(19) United States
(12) Patent Application Publication
(10) Pub. No.: US 2011/0272096 A1
(43) Pub. Date: Nov. 10, 2011

(54) PATTERN SHAPE INSPECTION INSTRUMENT AND PATTERN SHAPE INSPECTION METHOD, INSTRUMENT FOR INSPECTING STAMPER FOR PATTERNED MEDIA AND METHOD OF INSPECTING STAMPER FOR PATTERNED MEDIA, AND PATTERNED MEDIA DISK MANUFACTURING LINE

(75) Inventors: Shigeru SERIKAWA, Kamisato (JP); Ryuta SUZUKI, Kamisato (JP); Toshiaki SUGITA, Kamisato (JP); Kiyotaka HORIE, Kamisato (JP)

(73) Assignee: HITACHI HIGH-TECHNOLOGIES CORPORATION, Tokyo (JP)

(21) Appl. No.: 13/103,635

(22) Filed: May 9, 2011

(30) Foreign Application Priority Data
May 10, 2010 (JP) 2010-108345
Jul. 8, 2010 (JP) 2010-155929

(51) Int. Cl. C23F 1/08; G01N 21/88

(52) U.S. Cl. 156/345.24; 356/237.2

(57) ABSTRACT

The present invention specifies a stamper that causes a defect at an early stage by inspecting a surface of a patterned medium and failure in molding of a pattern shape of a stamper at high speed or extracting a defect resulting from the stamper based upon a defect of a pattern on a disk so as to prevent the occurrence of a large quantity of failure beforehand. In the present invention, in order to inspect a pattern shape, wide-band light including a deep ultraviolet ray is radiated onto an inspected object, reflected light generated from the inspected object irradiated by an radiating optical system is detected, and it is judged whether the channel spectral data having fixed wavelength width of the detected reflected light exists within set limit or not. Similarly, the stamper is judged defective when the reflected light is diffracted and detected, detected spectral reflectance waveform data is compared with reference data, a defective area of a pattern of a resist film is extracted and the defective area acquired in the inspection data of the current inspection is the same as defective areas acquired in the inspection data of plural substrates inspected using the same stamper.

### FIELD OF THE INVENTION

The present invention relates to a pattern (of patterned media and others) shape inspection instrument and a pattern shape inspection method, an instrument for inspecting a stamper for patterned media and a method of inspecting the stamper for patterned media, and a patterned media disk manufacturing line.

### BACKGROUND OF THE INVENTION

Recently, as for a hard disk drive, not only the utilization for a server and a computer increases but the utilization for various applications such as a hard disk recorder for home use, car navigation and portable AV reproduction equipment extend, and in addition, its capacity also has a tendency to increase according to the digitization of various applications.

The increase of the capacity means the increase of the recording density of a disk as a medium. For a high density recording method corresponding to the increase of the capacity, a vertical magnetic recording method is developed. Currently, the further enhancement of recording density is demanded, however, in the vertical magnetic recording method, an effect by magnetic interference between adjacent tracks grows too great to be ignored as recording density increases. For a recording method of the next generation for settling this problem, a patterned medium as a recording medium where a pattern is molded on a surface of a disk is researched and the practical use in future is expected.

Patterned media have two types of discrete track media and bit patterned media respectively shown in FIG. 2. The discrete track media (DTM) mean a method of molding a concentric track pattern 14 on a disk 1 as shown on the left side of FIG. 2 and the bit patterned media mean a method of molding an innumerable bit pattern 16 as shown on the right side of FIG. 2.

For the methods of molding the patterns, a method of using nano imprinting technology in which a pattern of an order of a nanometer at a low cost can be mass-produced is regarded as influential. The nano imprinting technology includes a method of pressing a stamper 20 (Step 1) made of quartz for example that transmits light on resist 15 which is applied to a surface of a disk substrate 12 where a magnetic film is formed so as to imprint (Step 2), exposing the resist 15 to light in this state (Step 3), forming a bit pattern 16 in the magnetic film by etching after the stamper 20 is separated (Step 4), removing the resist afterward and burying a non-magnetic film 17 (Step 5) and forming a protective film 18 on the surface (Step 6) as shown in FIG. 3.

The dimension of the pattern molded in the patterned medium is 100 nm or less, a case that a result of the pattern as a result of the developed resist is inspected exceeds a limit of development when a microscope using light of a wavelength in a visible radiation area is used, and an image of the pattern cannot be observed.

When a pattern molded by nano imprinting has dispersion in size and a shape, a defect and shortness, normal operation is not performed and the corresponding product may be judged defective. Therefore, it is required to inspect whether a shape of a pattern is suitably molded or not and to manage the shape of the pattern.

For a cause of failure, refuse (a foreign matter) produced in a process, the variation of a condition of a process, a defect brought from the last process and a defect caused due to failure in a shape of a stamper can be given. Out of these, the defect caused due to the failure in the shape of the stamper is caused every time as long as the stamper defective in the shape is used and may extremely reduce the yield of a product.

For a method of inspecting a minute defect such as the failure in the shape of the stamper, a method of observing with a scanning electron microscope (SEM) and a method of observing a surface of a sample with an atomic force microscope (AFM) are used, however, the throughput is low in both methods and the methods are not suitable for inspecting more disks in a field of production.

In the meantime, a method of inspecting using a principle of scatterometry is used for the management of a process for forming a minute pattern in a production line of a semiconductor device. In this method, a test element group (TEG) pattern for process management is molded in a part except an area where a device is formed on a semiconductor wafer and a shape of the TEG pattern is detected using data acquired by diffracting reflected light from the pattern so as to manage the process.

Measuring the roughness of an edge of the pattern applying the principle of scatterometry is disclosed in U.S. Pat. No. 7,233,390. Besides, the inspection using scatterometry of patterned media is disclosed in JP-A No. 2007-133985.

Besides, it is disclosed in JP-A No. 2010-91295 that data inspected according to scatterometry and data acquired by radiating a laser beam onto a surface of a substrate and detecting reflected light from the substrate at a first elevation angle and at a second elevation angle are compared so as to detect a defect in a shape of the surface of the substrate.

Further, JP-A No. 2007-123182 discloses a method of inspecting a pattern shape and the roughness of an edge by radiating light onto a substrate, diffracting and detecting its reflected light, detecting the roughness of the edge of the pattern by radiating a laser beam onto the substrate from a diagonal direction and detecting its scattered light and calculating the roughness of the edge of the pattern by analyzing data acquired by diffracting and detecting the reflected light when the roughness of the edge is detected based upon the detection data of the scattered light.

For a method of inspecting a minute pattern, a method of optically inspecting according to scatterometry is disclosed in U.S. Pat. No. 7,233,390, JP-A No. 2007-133985, JP-A No. 2010-91295, and JP-A No. 2007-123182. Besides, it is described in JP-A No. 2007-133985, JP-A No. 2010-91295, and JP-A No. 2007-123182 that the method of optically inspecting is applied to the inspection of a minute pattern of patterned media molded by nano imprinting.

Furthermore, a method of detecting a surface of a patterned media disk and a defect of a pattern of a stamper is disclosed in JP-A No. 2009-257993. In this method, for example, light including plural wavelengths is radiated onto a surface of a patterned medium on which a magnetic pattern is molded, a spectral reflectance waveform of its reflected light (hereinafter called zero-dimensional light) is calculated in each position of the patterned medium, the calculated spectral reflectance waveform and a reference spectral reflectance waveform are compared and a shape of the pattern molded on the patterned medium is inspected.

### SUMMARY OF THE INVENTION

However, when the failure in molding of a pattern shape is inspected according to the method proposed in JP-A No. 2009-257993, there occurs a problem that the inspection requires much time because spectral reflectance waveforms are calculated in all positions and are compared with the reference spectral reflectance waveform.

Besides, when a stamper used for manufacturing patterned media is defective, the defect of the stamper is transcribed in all patterned media nano-imprinted using the stamper and a large quantity of defectives may be produced.

Then, when patterned media are formed by nano imprinting, it is required to be identified whether a defect caused on a disk of a pattern is commonly caused among plural disks formed by the same stamper or the defect is caused at random without being common to the plural disks.

However, in the above-mentioned any patent document, the identification of whether the defect caused on the disk of the pattern results from the stamper or is caused at random is not considered.

A first object of the present invention is to settle the problems of the above-mentioned related art and to provide a pattern shape inspection instrument or a pattern shape inspection method for enabling inspecting failure in molding a surface of a patterned medium and a pattern shape of a stamper at high speed and a patterned media disk manufacturing line.

A second object of the present invention is to settle the problems of the above-mentioned related art and to provide a patterned media inspection instrument for enabling extracting a defect resulting from a stamper based upon the defect caused on a disk of a pattern, specifying the stamper which is a cause of the defect at an early stage and previously preventing a large quantity of failure from being caused and a method of inspecting the stamper for patterned media using the patterned media inspection instrument.

To achieve the first object, the present invention has a first characteristic that an inspected object where a pattern is molded is laid and is moved in a radial direction, being rotated, wide-band light including a deep ultraviolet ray is radiated onto the inspected object, zero-dimensional reflected light generated from the inspected object irradiated by an radiating optical system is detected, channel spectral data having fixed wavelength width is acquired from the detected zero-dimensional reflected light, it is judged whether the channel spectral data exists within set limit or not and a pattern shape molded in the inspected object is inspected based upon a result of the judgment.

Besides, the present invention has a second characteristic that in the inspection of the shape, a degree of failure in molding is evaluated based upon difference between the channel spectral data acquired beforehand of a non-defective product in molding and the channel spectral data of the inspected object in addition to the first characteristic to achieve the first object.

Further, to achieve the object, the present invention has a third characteristic that in the inspection of the shape, a sign showing the difference is acquired by calculation in addition to the second characteristic.

Beside, to achieve the first object, the present invention has a fourth characteristic that in the judgment, a group of channel spectral data pieces in which the channel spectral data outside the set limit exists is stored as defective spectral data, in the inspection of the shape, defective spectral data pieces adjacent to the inspected position of the defective spectral data are connected and a type of the defect is judged as a linear, plane or dotty defect in addition to the first characteristic.

Further, to achieve the first object, the present invention has a fifth characteristic that in the inspection of the shape, a sign showing difference between the defective spectral data configuring the type of the defect and the group of the channel spectral data pieces corresponding to the defective spectral data and acquired beforehand of the non-defective products in molding is acquired by calculation in addition to the fourth characteristic.

In addition, to achieve the first object, the present invention has a sixth characteristic that the pattern shape inspection instrument having any of the first to fifth characteristics that inspects a shape of a transcribed pattern is provided to a patterned media disk manufacturing line for manufacturing a patterned media disk by applying resist to a disk provided with a magnetic layer, transcribing a pattern on a resist-applied surface using servo information and a stamper where the pattern such as data tracks is mold and executing dry etching using a transcribed resist pattern as a mask.

Further, to achieve the first object, the present invention has a seventh characteristic that the pattern shape inspection instrument having any of the first to fifth characteristics that inspects a shape of a pattern before a non-magnetic layer is formed or after the non-magnetic layer is formed is provided to a patterned media disk manufacturing line for manufacturing a patterned media disk by applying resist to a disk provided with a magnetic layer, transcribing a pattern on a resist-applied surface using servo information and a stamper where the pattern such as data tracks is molded, executing dry etching using a transcribed resist pattern as a mask so as to form a pattern in the magnetic layer and burying a non-magnetic film in a concave portion of the pattern.

Besides, to achieve the second object, in the present invention, based upon a method of detecting the failure of a stamper that transcribes a minute pattern in a resist film applied to a substrate by nano imprinting, light is radiated onto the pattern molded in the resist film of the substrate by nano imprinting using the stamper, reflected light from an area of the substrate irradiated by the light is diffracted and detected, spectral reflectance waveform data detected by diffraction is compared with reference data stored beforehand and an area where abnormality occurs in the pattern of the resist film formed on the substrate is extracted, the information of the extracted area where the abnormality occurs is compared with the inspection data pieces of plural substrates nano-imprinted using the same stamper and inspected immediately before the substrate is inspected, when the abnormality is also detected in the same area as the area where the abnormality occurs in the plural substrates inspected immediately before, the stamper is judged defective.

In addition, to achieve the second object, a patterned media inspection instrument according to the present invention is provided with a light radiating section that radiates light onto a pattern molded in a resist film applied to a substrate using a stamper, a diffracting/detecting section that diffracts and detects reflected light from the substrate onto which the light is radiated by the light radiating section, a storing section that stores reference data and past inspection data pieces respectively of a spectral reflectance waveform, a defective area extracting section that compares spectral reflectance waveform data diffracted and detected by the diffracting/detecting section with the reference data of the spectral reflectance waveform stored in the storing section and extracts an area where abnormality occurs of the pattern in the resist film molded on the substrate, a data comparing section that compares the information of the area where the abnormality occurs extracted by the defective area extracting section with the inspection data pieces stored in the storing section of plural substrates nano imprinted using the same stamper and inspected immediately before the substrate is inspected and an abnormality judging section that judges the stamper defective when abnormality is detected in the same area as the area where the abnormality occurs of the substrate in the plural substrates inspected immediately before the substrate is inspected as a result of the comparison by the data comparing section.

According to the present invention, the patterned media inspection instrument that can inspect the failure in molding of a surface of the patterned medium and the failure in molding of a pattern shape of the stamper at high speed, the inspection method and the patterned media disk manufacturing line can be provided.

In addition, according to the present invention, a defect resulting from the stamper can be extracted based upon the defect of the pattern on the disk, the stamper that causes the defect can be specified at an early stage, and a large quantity of failure can be prevented from being caused beforehand.

### BRIEF DESCRIPTION OF THE DRAWINGS

FIG. 1 shows the configuration of a pattern shape inspection instrument equivalent to a first embodiment of the present invention;

FIG. 2 is a schematic diagram showing one example of patterned media;

FIG. 3 is a process drawing showing a nano printing process;

FIG. 4A shows a pattern of resist as an example of an inspected location in a discrete track medium and FIG. 4B shows an uneven pattern of a magnetic layer as an example of an inspected location in the discrete track medium;

FIG. 5 shows a flow of a process for detecting failure in molding in the embodiment of the present invention;

FIG. 6 shows a signal waveform of each channel ch which is the output of a linear detector of a spectroscope;

FIG. 7 shows one example of a spectral data waveform of a non-defective product in molding and a spectral data waveform of an inspected object in the embodiment of the present invention;

FIG. 8 schematically shows one example of a result of judgment displayed on an I/O terminal;

FIG. 9 shows a DTM manufacturing system related to patterning of a DTM manufacturing line which is one example of a patterned media disk manufacturing line in the embodiment of the present invention;

FIG. 10 is a block diagram showing the whole configuration of a patterned media inspection instrument;

FIG. 11 is a plan showing a patterned medium;

FIG. 12 shows a flow of a process for detecting the failure of a stamper;

FIG. 13 is a graph showing a spectral reflectance waveform acquired by detecting a sample and a reference spectral reflectance waveform corresponding to the waveform with the waveforms overlapped;

FIG. 14 is a front view showing a screen for inputting a repeated frequency; and

FIG. 15 is a front view showing a screen for displaying that the stamper is defective.

### DETAILED DESCRIPTION OF THE PREFERRED EMBODIMENTS

Referring to the drawings, one embodiment of the present invention will be described below.

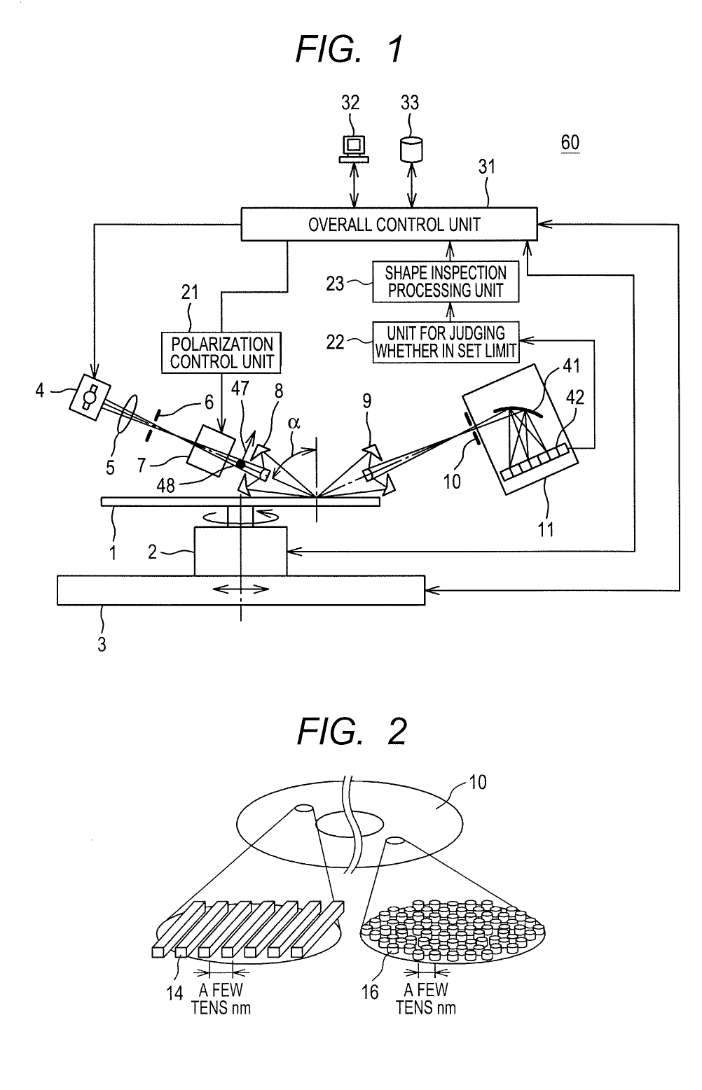

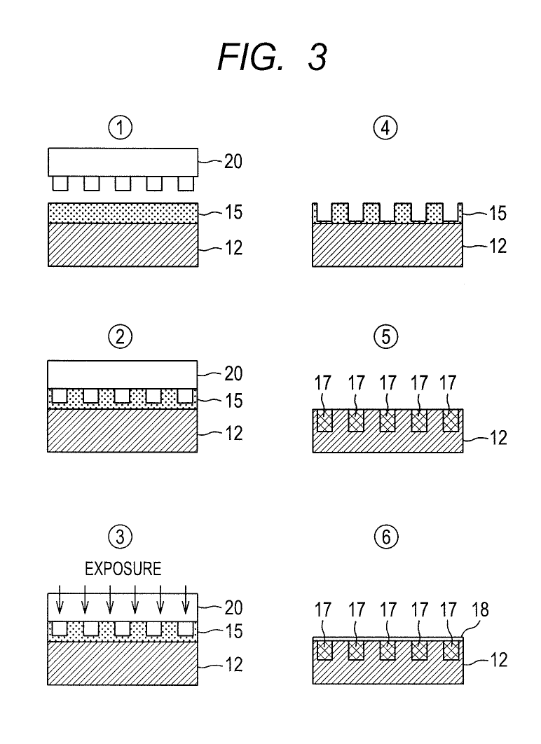

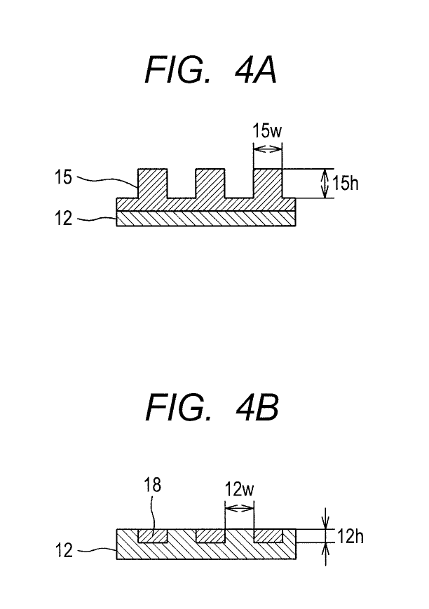

First, referring to FIG. 1, the configuration of a pattern shape inspection instrument 60 equivalent to a first embodiment of the present invention will be described. For an uneven pattern on a DTM disk (hereinafter merely called a disk) as an inspected object, for example, a pattern (see FIG. 4A) of resist 15 and an uneven pattern (see FIG. 4B) of a magnetic layer 12 before a non-magnetic layer is formed or before and after a non-magnetic layer is formed are supposed, and a condition of the shaping of each land having 15h, 12h as the height (the depth) of each pattern and 15w, 12w as the width is inspected.

The pattern shape inspection instrument is provided with a moving mechanism configured by θ stage 2 that mounts and rotates an inspected object 1 which is a disk and X stage 3 that moves the θ stage 2 in one direction so as to move the inspected object in a radial direction with the inspected object laid and rotated. The whole surface of the inspected object 1 can be scanned by the moving mechanism.

Besides, the pattern shape inspection instrument is provided with an radiating optical system configured by a wide-band illuminant 4 that emits wide-band light including a deep ultraviolet (DUV) ray, a condensing lens 5 that focuses the emitted light, a field stop 6 that determines a detection field on the inspected object, a polarizing prism (a polarizing optical element) 7 that polarizes the emitted light in a specific direction so as to suit a direction of the emitted light to that of the inspected object 1, an radiating lens 8 that images the emitted light polarized in the specific direction on the inspected object 1 and a polarization control unit 21 that controls the rotation of the polarizing prism 7, a detection system configured by an objective 9 that images zero-dimensional reflected light from a disk 1 which is the inspected object and a diaphragm 10 that screens stray light and others and a spectroscope 11 configured by a diffraction grating 41 that diffracts detected light (the zero-dimensional reflected light) and a linear light detector 42 that detects a spectral waveform diffracted by the diffraction grating 41.

Further, the pattern shape inspection instrument is provided with a shape inspection section configured is provided with a shape inspection section configured by a unit for judging whether in a set limit 22 that receives the spectral waveform detected by the spectroscope 11, converts it to digital one and judges whether digitized spectral reflection intensity is in a set limit or not and a shape inspection processing unit 23 that inspects a pattern shape of the inspected object 1 based upon decision data acquired in the unit for judging whether in the set limit or not, an overall control unit 31 that controls the whole sequence, an I/O terminal 32 and a database 33 respectively connected to the overall control unit 31.

To inspect the shape of the uneven pattern on the disk, it is necessary that the variation of reflection intensity by a change of the pattern shape is great and shape change detection sensitivity is great. Therefore, emitted light controlled (modulated) so that a polarization direction is suitable for the inspected object is made incident on the inspected object 1 from a diagonal direction and zero-dimensional reflected light (regularly reflected light) from the inspected object 1 is detected from a diagonal direction. Besides, the reflectance is increased by making emitted light incident from the diagonal direction even if the inspected object is a stamper made of quartz which ultraviolet rays including a deep ultraviolet ray penetrate, the detected quantity of light is increased, and the sensitive inspection of a pattern shape is enabled.

Next, the operation of the pattern shape inspection instrument will be described. The inspected object 1 is held on the θ stage 2, is rotated, is moved in one direction by the X stage 3, and a position in which the θ stage 2 is rotated and a position in which the X stage 3 is moved are input to the overall control unit 31. The wide-band illuminant 4 emits wide-band (multi-wavelength) light including a deep ultraviolet (DUV) ray (the wavelength is 200 to 500 nm for example) and for example, a xenon lamp, a halogen lamp, a deuterium lamp or the combination of them is used. The emitted light is incident in a radial direction of the inspected object 1, that is, in a substantially perpendicular direction to a direction of the pattern of the disk at an incidence angle α from the diagonal direction. The emitted light from the wide-band illuminant 4 is focused on the field stop 6 by the condensing lens 5. An image on the field stop 6 is imaged on the inspected object by the reflection type radiating lens 8 and a detection field of view is formed. At that time, a direction in which the emitted light is polarized (P polarized light 47, S polarized light 48) is selected and set according to control over the rotation of the polarizing prism 7 from the polarization control unit 21 so as to make the direction suitable for a type of the inspected object. The direction in which the emitted light is polarized is selected and set so as to make the direction suitable for the type of the inspected object by determining polarized directions of the emitted light beforehand based upon conditions for sensitively measuring the pattern shape of the inspected object 1 as described later and storing them in the database 33. When the field stop 6 is in the shape of a square the four sides of which have the same dimension, the detection field on the inspected object 1 is in the shape of a rectangle longer by 1/cos α times in a direction of an optical axis because of diagonal incidence. Then, a shape of the field stop 6 is determined in consideration of it.

Zero-dimensional reflected light (regularly reflected light) from the pattern of the inspected object 1 is focused by the objective 9 and is imaged on the diaphragm 10. For the radiating lens 8 and the objective 9, a reflector type lens the loss due to absorption of which is small and which can reduce chromatic aberration in a deep ultraviolet (DUV) area of the emitted light is used. The diaphragm 10 screens stray light and light not imaged on the diaphragm 10 because the size is made correspond to the size of the detection field on the inspected object 1. For example, a part of light incident on the inspected object 1 penetrates the surface of the inspected object 1, is reflected on the back of the inspected object 1, reaches the surface of the inspected object 1 again, and is outgoing in a direction parallel to zero-dimensional reflected light from the surface of the inspected object 1.

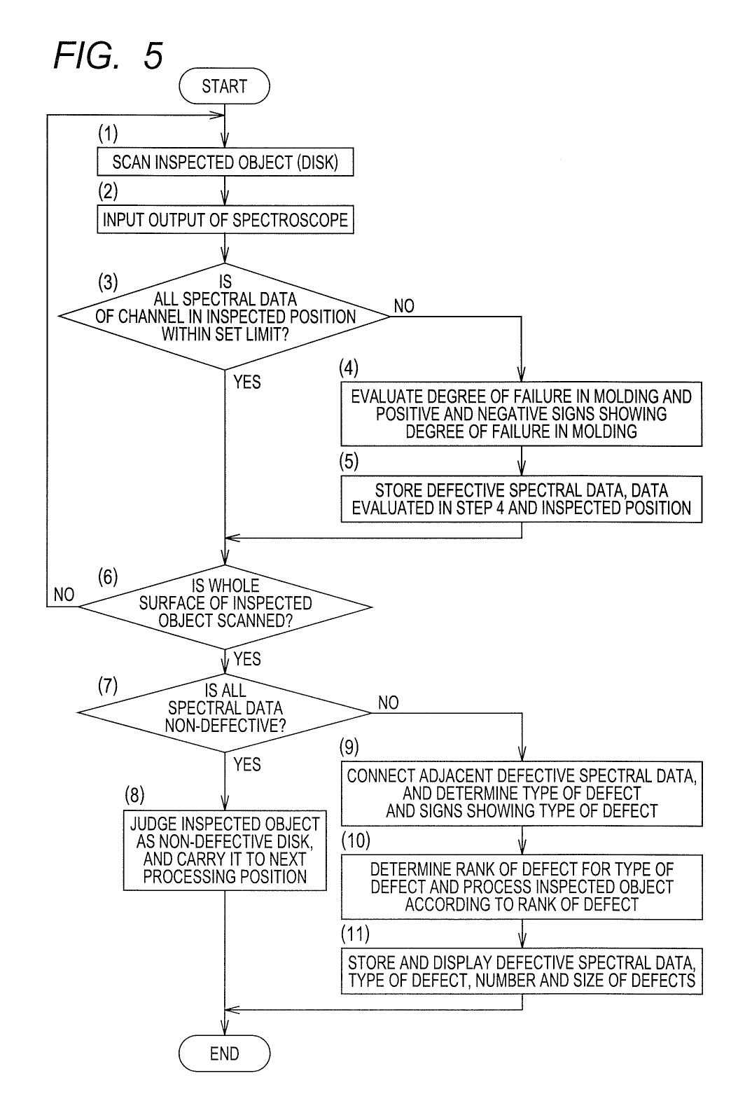

Next, a method of detecting failure in molding which is the most characteristic in this embodiment will be described. FIG. 5 shows a flow of a molding failure detecting process. The detecting process is executed by the shape inspection section configured by the unit for judging whether in the set limit or not 22 that judges whether spectral reflection intensity is in set limit or not and the shape inspection processing unit 23 that inspects the pattern shape of the inspected object 1 based upon decision data acquired in the unit for judging whether in the set limit or not and the overall control unit 31.

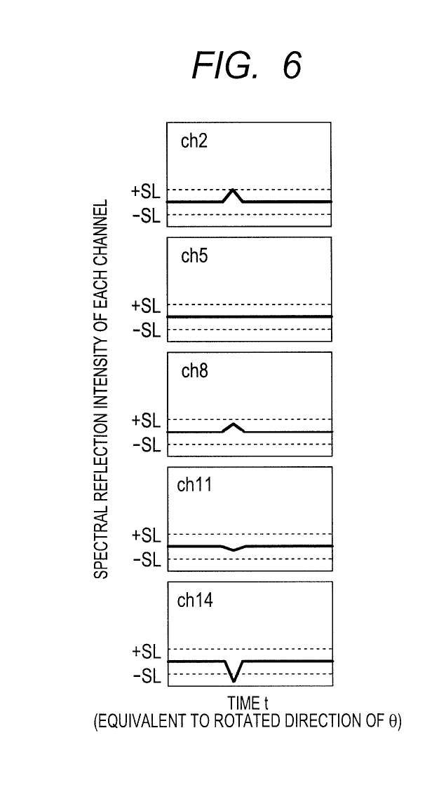

First, the overall control unit 31 starts to scan the inspected object 1 under control over the θ stage 2 and the X stage 3 (Step 1). Afterward, the unit for judging whether in the set limit or not 22 inputs the output of the spectroscope 11 converted from digital to analog every predetermined interval (time or distance) (Step 2). The linear detector 42 of the spectroscope 11 is provided with 16 channels ch the width of which is 20 nm and covers a range of 200 to 500 nm. FIG. 6 shows a signal waveform of each channel ch. An axis of ordinates in FIG. 6 shows spectral reflection intensity which is spectral data and an axis of abscissas shows time equivalent to a direction of the rotation of the θ stage 2 (see FIG. 1). “+SL” on the axis of ordinates shows an upper limit slice level regarded as normal and “−SL” similarly shows a lower limit slice level.

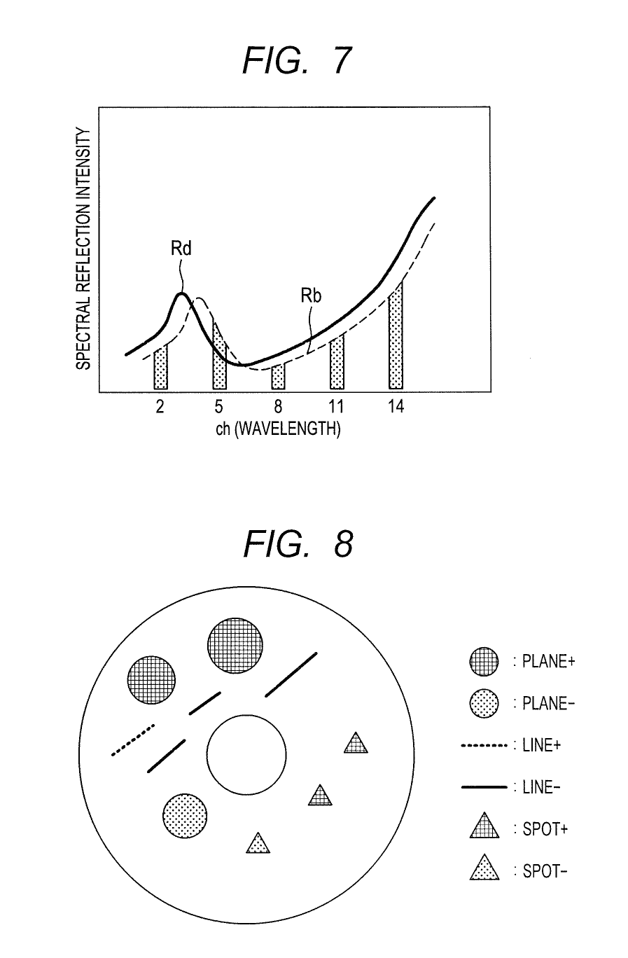

Next, the unit for judging whether in the set limit or not 22 judges whether spectral data detected every channel ch in an inspection position is in the set limit, that is, within ±slice levels or not (Step 3). All the 16 channels are not necessarily required to be used in inspection and the channel easy to grasp failure or plural channels selected at an equal interval may also be selected beforehand. FIG. 7 shows a spectral data waveform Rd of a non-defective product and a spectral data waveform Rb of the inspected object and in this embodiment, the channels 2, 5, 8, 11 and 14 every three channels are selected and are inspected.

The shape inspection processing unit 23 judges that the corresponding object is defective when even one of the inspected channels is out of the limit and makes control jump to Step 4, and makes control jump to Step 6 when all the inspected channels are in the limit.

In Step 4, the shape inspection processing unit 23 evaluates a degree E of failure in molding shown in the following expression (1) and positive and negative signs F shown in the following expression (2) based upon the spectral data of the non-defective product and the spectral data of the inspected object respectively shown in FIG. 7.

E=Σn|Rdch(n)−Rbch(n)|)/N (1)

In this case, Rdch(n): Spectral data of channel n of non-defective product
Rbch(n): Spectral data of channel n of inspected object
N: Number of channels used in inspection.

F=+:Σ(Rdch(n)−Rbch(n))>0

−:Σ(Rdch(n)−Rbch(n))<0 (2)

‘+’ as a sign showing the degree E of failure in molding means that zero-dimensional light is more intense, compared with that of the non-defective product and this shows that the height 15h (the depth 12h) of the land shown in FIG. 4 is higher (deeper), compared with that of the non-defective product. Conversely, ‘−’ as a sign means that the height 15h (the depth 12h) of the land is lower (shallower). Accordingly, a direction of the failure in molding of the inspected object can be known by showing the signs.

Next, the degree of the failure in molding, the positive and negative signs showing the degree of the failure in molding, the spectral data (the defective spectral data) of all the inspected channels and the inspection position are stored (Step 5) and the process proceeds to Step 6. The inspection position can be defined based upon positions of the θ stage 2 and the X stage 3.

In Step 6, the overall control unit 31 judges that all positions on the disk 1 are scanned. After all the positions are scanned, the shape inspection processing unit 23 judges whether defective spectral data exists or not (Step 7). When no defective spectral data exists, the inspected object is judged a non-defective disk and is carried to the next processing position (Step 8). When defective spectral data exists, the process proceeds to Step 9.

In Step 9, the shape inspection processing unit 23 connects the defective spectral data and the adjacent defective spectral data adjacent to the inspected position, determines a type of a defect such as a line, a plane and a spot, and determines a sign showing the type of the defect based upon the positive or negative sign showing the degree of the failure in molding in the defective spectral data configuring the type of the defect. In this case, the degree of failure in molding as the type of the defect and the positive and negative signs showing the degree of the failure in molding may also be calculated using all channel defective data pieces of all defective data pieces as in the expressions (1) and (2).

Next, the rank of the defect is determined based upon the degree of the failure in molding of the type of the detect, the positive and negative signs showing the degree of the failure in molding, the type of the detect, the number and the size of defects, and the disk is processed according to the rank of the defect (Step 10). For example, when the rank of the defect is 0 which is the lowest rank, the defect is considered to be within the limit and the inspected object is carried to the next processing position. When the rank of the defect is above 1, the inspected object is judged a defective and is ejected out of a manufacturing line.

Finally, the defective spectral data, the type of the defect, the number and the size of defects are stored in the database 33 and a result of determination is displayed on the I/O terminal 32 (Step 11). FIG. 8 schematically shows one example. When the defect in FIG. 8 is specified, the type and the size of the defect and a power level for example are displayed on the I/O terminal 32. Their data pieces are prepared as a data list to be displayed when the defect is specified beforehand when the data is stored in the database 33.

According to the embodiment described above, the failure in molding of the disk can be detected by merely providing the slice level to each channel without calculating the spectral data waveforms of all the channels every inspection position.

Besides, according to the embodiment described above, as the degree E of the failure in molding of the required channels is calculated only when failure in molding is detected, the inspected object such as a disk can be inspected at high speed.

In the embodiment described above, the unit for judging whether in the set limit or not 22 is configured by software, however, the output of each channel has only to be read only when a defect is detected by providing a comparator provided with the upper limit slice level +SL and the lower limit slice level −SL respectively shown in FIG. 6 as a comparative level to each channel and ORing the output of the comparator of each channel, and the inspected object can be inspected at further higher speed.

In addition, in the embodiment described above, reflected light is detected by the spectroscope, however, reflected light is detected by a light receiving element, frequency analysis is performed based upon detected data, and the spectral data of each channel may also be acquired.

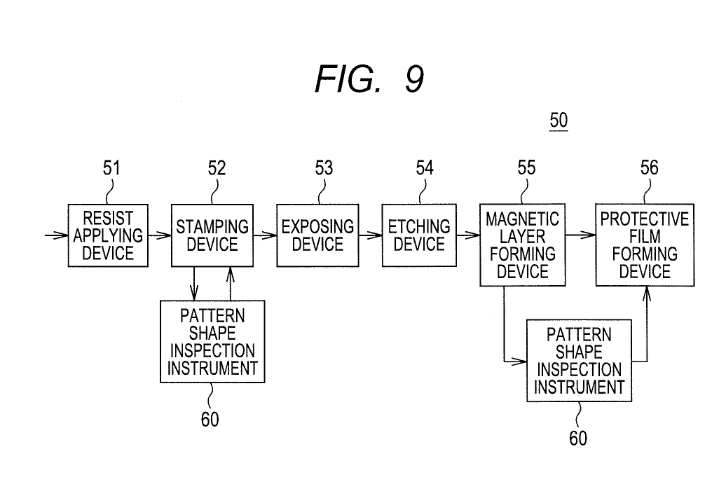

FIG. 9 shows a DTM manufacturing system 50 related to patterning in a DTM manufacturing line which is one example of a patterned media disk manufacturing line. The DIM manufacturing line includes a device for a process for forming a magnetic layer on a glass substrate and a device for a process for cleaning a surface of a disk on the upstream side of the DTM manufacturing system related to patterning and a device for forming a lubricating film on the downstream side of the DIM manufacturing system related to patterning.

The DTM manufacturing system related to patterning is provided with a resist applying device 51 that spin-coats the surface of the disk with resist, a stamping device 52 that imprints a pattern on a resist-applied surface using servo information and a stamper where a pattern such as data tracks is molded, an exposing device 53 that exposes in a stamped state, an etching device 54 that performs dry etching using a resist pattern for a mask so as to form channels on the surface of the disk, a non-magnetic layer forming device 55 that buries a non-magnetic layer in the channel, a protective film forming device 56 that forms a protective film on the surface of the disk and the pattern shape inspection instrument 60 that inspects a shape of a pattern of the disk.

The pattern shape inspection instrument 60 is provided on the downstream side of the stamping device 52 and the non-magnetic layer forming device 55 so that it can be inspected whether the pattern shape sampled at a fixed rate is satisfactory or not after immediately after the pattern is imprinted by the stamper and after the non-magnetic film is formed. When it is judged that the pattern shape is defective as a result of inspection, the disk is discarded without returning it to the stamping device 52 or the protective film forming device, and when it is judged that the pattern shape is non-defective, the disk is returned to the stamping device or the protective film forming device. Besides, when the frequency of defectives increases, the fact is displayed on a monitor and others to tell operators and according to circumstances, the DTM manufacturing line is stopped.

According to the embodiment of the DTM manufacturing line described above, as it is inspected in short time whether the pattern shape is satisfactory or not, tuts of the DTM manufacturing line can be enhanced.

In the above-mentioned embodiment, the patterned medium is described as the inspected object, however, the irregularities of the stamper 20 and further, a mold of the stamper for forming the stamper may also be inspected as described in an item of the problem.

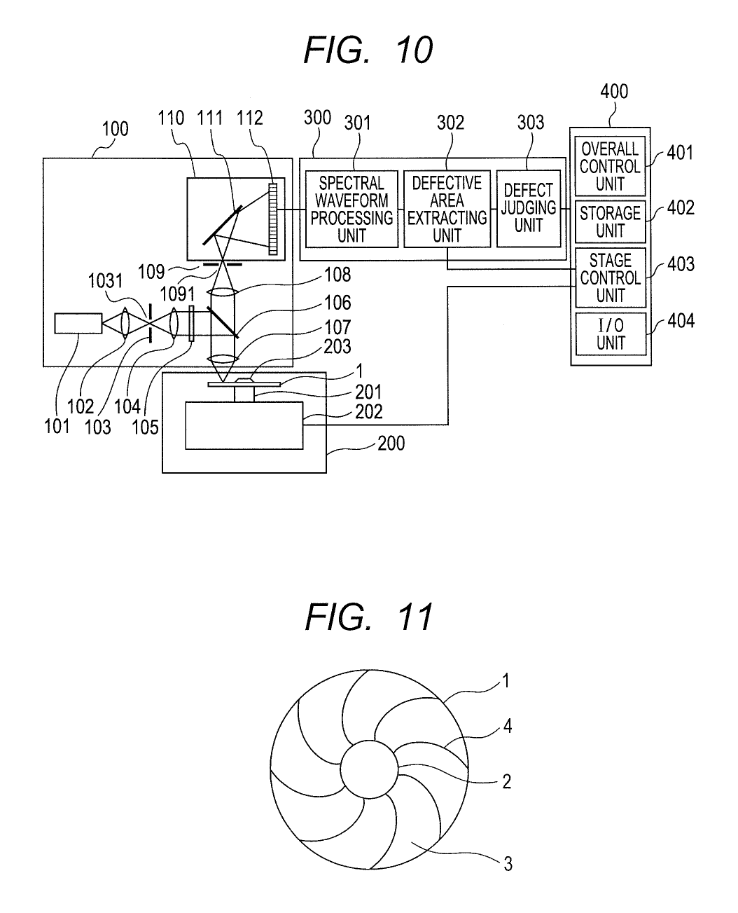

Next, a second embodiment of the present invention will be described referring to the drawings. First, FIG. 10 shows the whole configuration of a patterned medium inspection instrument in this embodiment. In the pattern shape inspection instrument 60 in the first embodiment, the emitted light is diagonally incident, however, in the second embodiment, a method of making emitted light vertically incident and inspecting reflected light vertically reflected is adopted.

The inspection instrument is provided with a detecting optical section 100, a stage section 200, a data processing section 300 and a control section 400.

The detecting optical section 100 is provided with an illuminant 101 that emits light, a condensing lens 102 that focuses the light emitted from the illuminant 101, a first field stop 103 having a pinhole 1031 for passing the light focused by the condensing lens 102, a collimator lens 104 that converts the light that passes the pinhole of the first field stop 103 to a parallel luminous flux, a polarizing plate 105 that adjusts a state of the polarization of the light that penetrates the collimator lens 104, a half mirror 106 that switches an optical path of the light the state of the polarization of which is adjusted by the polarizing plate 105 to the side of a disk which is a sample 1, an objective that focuses the light which is the parallel luminous flux the optical path of which is switched by the half mirror 106 so as to illuminate a surface of the sample 1, an imaging lens 108 that focuses and images reflected light which is incident on the objective 107 again and which penetrates the half mirror 106 out of reflected light from the sample 1 illuminated by the light, a second field stop 109 having a pinhole 1091 for passing the reflected light which penetrates the imaging lens 108 and a spectroscope 110 that accepts the reflected light that passes the second field stop 109.

The spectroscope 110 is provided with a diffraction grating 111 that receives the reflected light that passes the second pinhole 1091 and diffracts it according to a wavelength and a linear detector 112 that separates the light diffracted by the diffraction grating 111 every wavelength and detects.

The stage section 200 is provided with a rotating stage 201 that rotates the laid sample 1 and a directly advancing stage 202 that moves the rotating stage 201 in one direction.

The data processing section 300 is provided with a spectral waveform processing unit 301 that converts a spectral detection signal output from the linear detector 112 of the spectroscope 110 from analog to digital so as to digitize the signal and acquires a spectral waveform of a predetermined channel as described in the first embodiment, a defective area extracting unit 302 that extracts a defective area of the sample 1 laid on the rotating stage 201 using the spectral reflectance waveform data (the spectral reflectance intensity) of the predetermined channel acquired from spectral waveform data digitized in the spectral waveform processing unit 301 and the positional information (a rotational direction and a radial direction) of the stage acquired from a stage control unit 403 described later and a defect determining unit 303 that processes defective area information extracted in the defective area extracting unit 302 and detects a defect of a shape of the stamper.

The control section 400 is provided with an overall control unit 401, a storage unit 402 that stores inspection data, substrate information and spectral data, the stage control unit 403 that controls the rotating stage 201 and the directly advancing stage 202 and an I/O unit 404 that inputs an inspection condition and outputs a result of inspection.

Next, the operation of the patterned medium inspection instrument equivalent to the second embodiment will be described.

The sample 1 which is an inspected object has plane structure shown in FIG. 11. The sample 1 is provided with a hole 2 in the center, and a data area 3 that stores data and a servo area 4 that records information for controlling a magnetic head (not shown) that reads and writes data are alternately formed on the surface. The sample 1 includes the one where an alignment mark as a positional reference is formed in a part except the data area 3 and the servo area 4 and the one where no alignment mark is formed. In this embodiment, a case that a substrate 1 on which no alignment mark is formed is inspected will be described.

The sample 1 is supported on the rotating stage 201 so that the hole 2 of the sample 1 is matched with a projection 203 of the rotating stage 201.

The rotating stage 201 is rotated at predetermined rotational speed with the sample 1 supported by the rotating stage 201 under control by the stage control unit 403. At this time, the directly advancing stage 202 is also controlled by the stage control unit 403 and is moved in one direction in accordance with the rotation of the rotating stage 201. The rotational position information of the rotating stage 201 and the positional information in a direct direction of the directly advancing stage are controlled by the stage control unit 403.

The illuminant 101 emits wide-band light including a deep ultraviolet (DUV) ray (a wavelength is 200 to 800 nm for example) and for example, a xenon lamp, a halogen lamp, a deuterium lamp or the combination of them is used.

Light emitted from the illuminant 101 is focused on the pinhole 1031 provided to the first field stop 103 by the condensing lens 102. An image of the pinhole 1031 by the focused light is imaged on the surface of the sample 1 via the collimator lens 104 and the objective 107 and a detection field is formed. At this time, the polarizing plate 105 is adjusted so that the focused light is suitable for a type of the sample 1 (a pattern shape molded on the surface of the sample 1) and a state of the polarization of the light is set. The half mirror 106 reflects a half of the light that penetrates the polarizing plate 105 on the side of the objective 107 and penetrates the residual half. That is, the luminous energy of light incident on the sample 1 is equivalent to a half of the luminous energy of the light emitted from the illuminant 101.

Reflected light (regularly reflected light) from the sample 1 on which the light is incident is condensed by the objective 107, a half of the condensed luminous energy penetrates the half mirror 106, is incident on the imaging lens 108, and is imaged of the pinhole 1091 of the second field stop 109.

The pinhole 1091 provided to the second field stop 109 is formed in accordance with the size of the image of the pinhole 1031 of the first field stop 103 projected on the sample 1 and screens stray light and light not imaged on the pinhole 1091.

The reflected light from the sample 1 that passes the pinhole 1091 provided to the second field stop 109 reaches the diffraction grating 111 of the spectroscope 110. The reflected light from the sample 1 that reaches the diffraction grating 111 is diffracted and reflected according to a wavelength, and is detected in the linear detector 112.

A spectral waveform detected in the linear detector 112 of the predetermined channel is input to the spectral waveform processing unit 301 and is converted from analog to digital to digitize the spectral waveform. The digitized spectral waveform is transmitted to the defective area extracting unit 302, is processed in the defective area extracting unit 302 based upon the positional information of the rotating stage 201 and the directly advancing stage 202 respectively from the stage control unit 403, and defective areas on the sample 1 are extracted.

A method of acquiring spectral reflectance waveform data from the spectral waveform data digitized in the defective area extracting unit 302 is as follows. First, beforehand, a substrate 1 before it is nano imprinted is irradiated by light, its reflected light is diffracted, detected digitized reference spectral waveform data is measured, and the data is stored in the storage unit 402. Next, spectral reflectance waveform data can be acquired by calculating the ratio of the reference spectral waveform data and spectral waveform data detected this time.

A method of extracting a defective area in the defective area extracting unit 302 is as follows. First, beforehand, spectral reflectance waveform data is calculated based upon spectral waveform data of a predetermined channel of a normal pattern and is stored in the storage unit 402. Next, a differential value every wavelength between the spectral reflectance waveform data acquired according to the above-mentioned procedure and the stored spectral reflectance waveform data of the predetermined channel of the normal pattern is calculated. Next, the total of differential values is compared with a preset reference value. As a result of the comparison, the positional data of the location that exceeds the reference value is acquired from the stage control unit 402 as the positional information (a rotated direction and a radial direction) of the stage and this proves a defective area.

The information of the defective area on the sample 1 extracted in the defective area extracting unit 302 is transmitted to the defect judging unit 303, patterns molded by the stamper used when the pattern molded in the sample 1 this time is molded by imprinting in units of nano in inspectional information stored in the storage unit 402 are inspected and are collated with the stored inspectional information, and it is checked whether a defective area detected in the same position as the defective area detected on the sample 1 this time exists in inspection data backed to the past by a number specified beforehand or not. When defective areas are also continuously detected in the same area as the substrate 1 in the past, the stamper is judged defective and the overall control unit 401 outputs warning via the I/O unit 404.

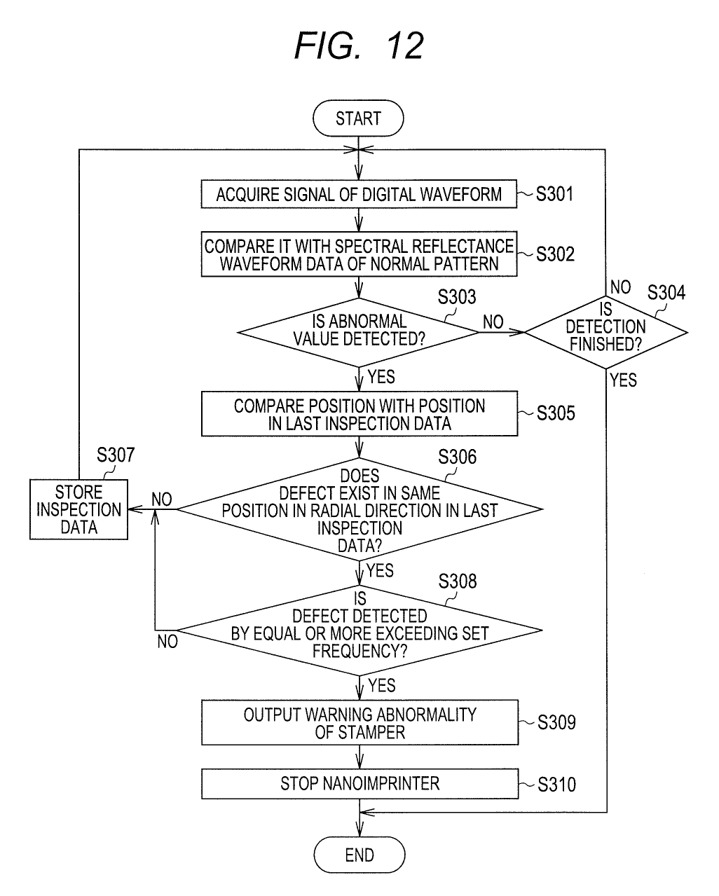

Next, the details of a flow for processing detection data in the data processing section 300 will be described referring to FIG. 12.

First, a digital spectral waveform signal is acquired by converting a spectral waveform detected in the linear detector 112 from analog to digital in the spectral waveform processing unit 301 (S301). Next, a digital spectral reflectance waveform data is acquired based upon the digital spectral waveform signal, is compared with the spectral reflectance waveform data of a normal pattern having a reference waveform based upon the positional information of the rotating stage 201 and the directly advancing stage 202 from the stage control unit 403 in the defective area extracting unit 302 (S302), and an abnormal value is extracted as a defective area on the sample 1 (S303). When abnormality is not detected, the similar processing of spectral waveform data in the next area is repeated until the inspection is finished (S304).

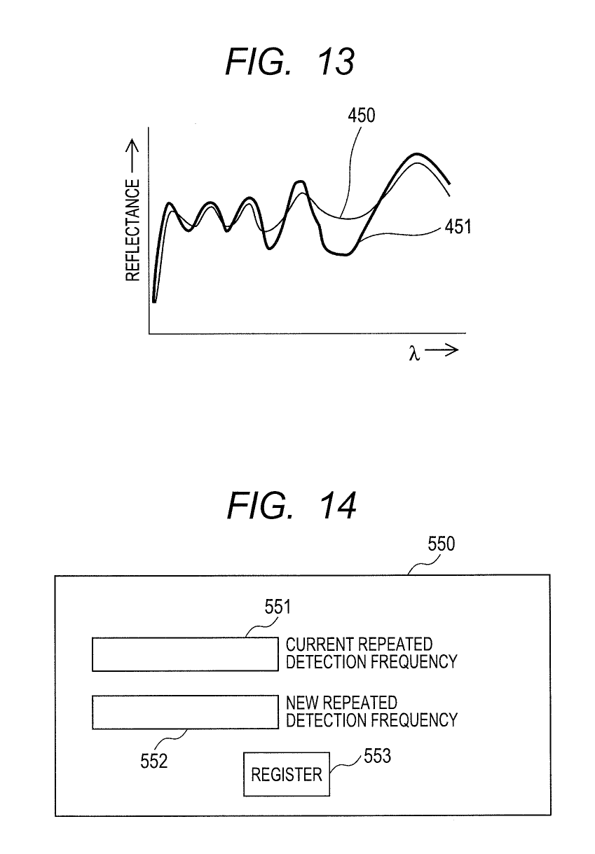

FIG. 13 shows one example of comparison between the digital spectral reflectance waveform data in S302 and the spectral reflectance waveform data of the normal pattern as the reference.

In FIG. 13, a reference numeral 451 denotes spectral reflectance waveform data acquired based upon the spectral waveform data of a certain area on the sample 1 output from the spectral waveform processing unit 301. In addition, a reference numeral 450 denotes the spectral reflectance waveform data of a normal pattern as a reference of an area corresponding to the certain area on the sample 1 stored in the storage unit 402.

As described above, a defective area is extracted by comparing the spectral reflectance waveform data 451 acquired from the detected spectral waveform data and the spectral reflectance waveform data 450 of the normal pattern as the reference according to the above-mentioned method.

When a defective area is extracted, the positional information of the defective area is compared with the inspection data inspected last time and stored in the storage unit 402 of the sample nano imprinted using the same stamper as this time (S305) and it is checked whether the common defective area also exists in the same position in the radial direction on the sample in the inspection data of the sample inspected last time or not (S306).

As a result, when no common defective area exists, the current inspection data is stored in the storage unit 402 (S307), control is returned to S301, and the inspection data of the next area is processed.

In the meantime, when the same defective area as this time exists in the last inspection data, the data pieces are compared with past data pieces of a preset number and it is checked whether the defective area common to them exists or not (S308). As a result, when no defect of the common areas exists in the past data pieces of the preset number, control proceeds to S307, the data of the defective area detected this time is stored in the storage unit 402, and control is returned to S301.

FIG. 14 shows one example of an input screen 550 for presetting the number traced back. The screen includes an area 501 for displaying the already set number and includes an area 502 for displaying a newly set number under the area 501. Further, a registration button 553 for registering the newly set number displayed in the area 502 is displayed.

In the meantime, when defects of the common areas exist in the past data pieces of the preset number, the overall control unit 401 issues an instruction to instruct the I/O unit 404 to sound an alarm for telling the abnormality of the stamper (S309) and stops a nanoimprinter (S310).

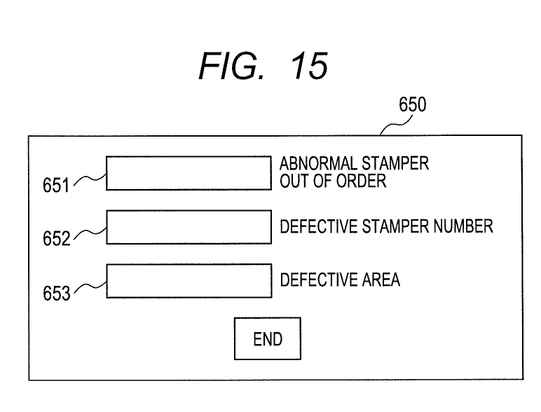

FIG. 15 shows one example of display on an output screen when the abnormality of the stamper is detected.

When it is judged in S308 that defects of the common areas exist in the past data pieces of the preset number, the overall control unit 401 issues an instruction to instruct the I/O unit 404 to make a display for telling the abnormality of the stamper in a stamper abnormality display area 651 on an abnormality display screen 650 (for example, in a case shown in FIG. 15, the stamper abnormality display area 651 is blinked), information for specifying the stamper estimated to be defective such as a registered number of the stamper is displayed in an area 652, and the positional information in the radial direction of the sample (the disk) of the defective area of the specified stamper is displayed in a display area 653. To finish the display of this abnormality information, an end button on the downside of the screen has only to be clicked.

In the second embodiment, the inspection is made without using all channel data pieces, however, the inspection may also be made using all channel data pieces.

The present invention made by these inventors has been concretely described based upon the embodiments, however, the present invention is not limited to the embodiments and it need scarcely be said that various modifications are allowed within a scope of its gist.

What is claimed is:

1. A pattern shape inspection instrument, comprising:
a movement mechanism that lays an inspected object where a pattern is molded and moves it in a radial direction while rotating it;
an radiating optical system that radiates wide-band light including a deep ultraviolet ray onto the inspected object moved in the radial direction while being rotated by the movement mechanism;
a detecting optical system that detects zero-dimensional reflected light generated from the inspected object irradiated by the radiating optical system;
a diffracting section that acquires channel spectral data in units of channel having a fixed wavelength width from the detected zero-dimensional reflected light;
a section for judging whether in a set limit that judges whether the channel spectral data exists within set limit or not; and
a shape inspecting section that inspects a pattern shape molded in the inspected object based upon a result of judgment by the section for judging whether in the set limit or not.

2. The pattern shape inspection instrument according to claim 1,
wherein the shape inspecting section evaluates a degree of failure in molding based upon a difference between the channel spectral data acquired beforehand of a non-defective product in molding and the channel spectral data of the inspected object.

3. The pattern shape inspection instrument according to claim 2,
wherein the shape inspecting section acquires a sign showing the difference by calculation.

4. The pattern shape inspection instrument according to claim 1,
wherein the section for judging whether in the set limit or not stores a group of channel spectral data pieces in which channel spectral data pieces outside the set limit exist as defective spectral data; and
the shape inspecting section connects adjacent defective spectral data pieces based upon an inspected position of the defective spectral data and determines a type of defect as a linear, plane or dotty defect.

5. The pattern shape inspection instrument according to claim 4, wherein:
the shape inspecting section acquires a sign showing a difference between the defective spectral data configuring the type of defect and a group of channel spectral data pieces corresponding to the defective spectral data and acquired beforehand of the non-defective products in molding by calculation.

6. The pattern shape inspection instrument according to claim 1,
wherein the diffracting section is a spectroscope that detects the reflected light in units of channel; and
the detecting optical system is provided with the spectroscope.

7. The pattern shape inspection instrument according to claim 1,
wherein the section for judging whether in the set limit or not is provided with a comparator provided with upper limit and lower limit slice levels in the set limit as set values.

8. The pattern shape inspection instrument according to claim 1,
wherein the diffracting section is a section that analyzes a frequency component in output of the detecting optical system.

9. The pattern shape inspection instrument according to claim 1,
wherein the inspected object is a discrete track medium or a bit patterned medium.

10. The pattern shape inspection instrument according to claim 1,
wherein the inspected object is a stamper which is a mold of a discrete track medium or a bit patterned medium, or a mold of the stamper.

11. A pattern shape inspection method, comprising steps of:
laying an inspected object where a pattern is molded and moving it in a radial direction while rotating it;
radiating wide-band light including a deep ultraviolet ray onto the inspected object;
detecting zero-dimensional reflected light generated from the inspected object irradiated by the radiating optical system;
acquiring channel spectral data having fixed wavelength width from the detected zero-dimensional reflected light;
judging whether the channel spectral data exists within set limit or not; and
inspecting a pattern shape formed in the inspected object based upon a result of the judgment.

12. The pattern shape inspection method according to claim 11,
wherein in the inspection of the shape, a degree of failure in molding is evaluated based upon a difference between the channel spectral data acquired beforehand of a non-defective product in molding and the channel spectral data of the inspected object.

13. The pattern shape inspection method according to claim 12,
wherein in the inspection of the shape, a sign showing the difference is acquired by calculation.

14. The pattern shape inspection method according claim 11,
wherein in the judgment, a group of channel spectral data pieces in which the channel spectral data outside the set limit exists is stored as defective spectral data; and
in the inspection of the shape, adjacent defective spectral data pieces are connected based upon the inspected position of the defective spectral data and a type of defect such as a linear, plane or dotty defect is determined.

15. The pattern shape inspection method according to claim 14,
wherein in the inspection of the shape, a sign showing a difference between the defective spectral data configuring the type of defect and a group of channel spectral data pieces corresponding to the defective spectral data and acquired beforehand of the non-defective products in molding is acquired by calculation.

16. A patterned media disk manufacturing line for manufacturing a patterned media disk by applying resist to a disk provided with a magnetic layer, transcribing a pattern on a resist-applied surface using a stamper where the patterns such as servo information and a data track are molded, and executing dry etching using a transcribed resist pattern for a mask, comprising:
the pattern shape inspection instrument according to claim 1 that inspects a shape of the transcribed pattern.

17. A patterned media disk manufacturing line for manufacturing a patterned media disk by applying resist to a disk provided with a magnetic layer, transcribing a pattern on a resist-applied surface using a stamper where the patterns such as servo information and a data track, executing dry etching using a transcribed resist pattern for a mask so as to mold a pattern in the magnetic layer and burying a non-magnetic film in a concave portion of the pattern, comprising:
the pattern shape inspection instrument according to claim 1 that inspects a pattern shape before or after the non-magnetic layer is formed.

18. A method of inspecting a stamper for patterned media of detecting a defect of a stamper that transcribes a minute pattern in a resist film applied to a substrate by nano imprinting, comprising steps of:
radiating light onto the pattern molded in the resist film on the substrate by nano imprinting using the stamper;
diffracting and detecting reflected light from an area of the substrate irradiated by the light;
comparing spectral reflectance waveform data diffracted and detected by diffracting with reference data stored beforehand and extracting an area where abnormality occurs in the pattern of the resist film formed on the substrate;
comparing the information of the area where the extracted abnormality occurs with inspection data pieces of a plurality of substrates nano imprinted using the stamper and inspected immediately before the substrate is inspected; and
judging that the stamper is defective when abnormality is also detected in the same area as the area where the abnormality occurs in the plurality of substrates inspected immediately before.

19. The method of inspecting the stamper for patterned media according to claim 18,
wherein as a result of the judgment that the stamper is defective, information for specifying the stamper judged defective and information for specifying a location where a defect occurs on the stamper are output.

20. The method of inspecting the stamper for patterned media according to claim 18,
wherein in a process for comparing with data acquired by inspecting one of the substrates in the past, the positional information in a radial direction from the center of the substrate of the area where the extracted abnormality occurs is compared with the positional information in a radial direction from the center of the substrate of a defective area detected in the inspection of one of the substrates in the past.

21. The method of inspecting the stamper for patterned media according to claim 18,
wherein in a process for judging the defect of the stamper, the stamper is judged defective when a frequency in which abnormality is continuously detected in the same area as the area where the abnormality occurs in the plurality of substrates inspected immediately before exceeds a preset frequency.

22. The method of inspecting the stamper for patterned media according to claim 18, further comprising:
a step for removing a pattern of the resist formed by nano imprinting by the stamper from the substrate and the plurality of substrates inspected immediately before when the stamper is judged defective.

23. A patterned media inspection instrument, comprising:
a light radiating section that radiates light onto a pattern molded using a stamper in a resist film applied to a substrate;
a diffracting/detecting section that diffracts and detects reflected light from the substrate onto which light is radiated by the light radiating section;
a storing section that stores reference data and past inspection data pieces respectively of a spectral reflectance waveform;
a defective area extracting section that compares spectral reflectance waveform data diffracted and detected by the diffracting/detecting section with the reference data of the spectral reflectance waveform stored in the storing section and extracts an area where abnormality occurs in the pattern of the resist film formed on the substrate;
a data comparing section that compares the information of the area where the abnormality occurs extracted by the defective area extracting section with data pieces stored in the storing section and acquired by inspecting a plurality of substrates nano imprinted using the stamper and inspected immediately before the substrate is inspected; and
an abnormality judging section that judges the stamper defective when abnormality is detected in the same area as the area where the abnormality occurs on the substrate in the plurality of substrates inspected immediately before the substrate is inspected as a result of comparison by the data comparing section.

24. The patterned media inspection instrument according to claim 23, further comprising:
an output section that outputs information for specifying the stamper judged defective and information for specifying a defective location on the stamper as a result of the judgment that the stamper is defective by the abnormality judging section.

25. The patterned media inspection instrument according to claim 23,
wherein the data comparing section compares the positional information in a radial direction from the center of the substrate of an area where abnormality occurs extracted by the defective area extracting section with the positional information in a radial direction from the center of each substrate of defective areas detected from a plurality of substrates inspected immediately before the substrate is inspected.

26. The patterned media inspection instrument according to claim 23,
wherein the abnormality judging section judges the stamper defective when a frequency in which abnormality is continuously detected in the same area as the area where the abnormality occurs in the plurality of substrates inspected immediately before exceeds a preset frequency.
